(19) United States
(12) Patent Application Publication
(10) Pub. No.: US 2024/0155709 A1
(43) Pub. Date: May 9, 2024

(54) REMOTE UE INITIAL ACCESS IN (LAYER 2) SIDELINK RELAY

(71) Applicant: Nokia Technologies Oy, Espoo (FI)

(72) Inventors: Ling YU, Espoo (FI); György Tamás WOLFNER, Budapest (HU); Vinh VAN PHAN, Oulu (FI); Lianghai JI, Aalborg (DK); Faranaz SABOURI-SICHANI, Aalborg (DK); Berthold PANZNER, Munich (DE); Rudraksh SHRIVASTAVA, Stuttgart (DE)

(21) Appl. No.: 18/546,688

(22) PCT Filed: Apr. 13, 2022
(86) PCT No.: PCT/FI2022/050248

§ 371 Date: Aug. 16, 2023

Related U.S. Application Data
(60) Provisional application No. 63/187,575, filed on May 12, 2021.

(51) Int. Cl. H04W 76/11

(52) U.S. Cl. CPC H04W 76/11; H04W 88/04

(57) ABSTRACT

A method and apparatus is provided wherein, a relay user equipment receives from at least one user equipment, a request to establish a radio resource control connection with a base station over a relay, transmits to the base station, a radio resource control message based, at least partially, on the request, receives from the base station, a message including, at least, a temporary identifier for the at least one user equipment and transmits at least the temporary identifier to the at least one user equipment.

### BACKGROUND

### Technical Field

The example and non-limiting embodiments relate generally to relay communication and, more particularly, to radio resource control connection establishment/reestablishment procedure.

### Brief Description of Prior Developments

It is known, in four-step contention based random access procedure, to assign a temporary C-RNTI to a UE in a random access response message.

### SUMMARY

The following summary is merely intended to be exemplary. The summary is not intended to limit the scope of the claims.

In accordance with one aspect, an apparatus comprising: at least one processor; and at least one non-transitory memory including computer program code; the at least one memory and the computer program code configured to, with the at least one processor, cause the apparatus at least to: receive, from at least one user equipment, a request to establish a radio resource control connection with a base station over a relay; transmit, to the base station, a radio resource control message based, at least partially, on the request; receive, from the base station, a message including, at least, a temporary identifier for the at least one user equipment; and transmit at least the temporary identifier to the at least one user equipment.

In accordance with one aspect, a method comprising: receiving, with a relay user equipment from at least one user equipment, a request to establish a radio resource control connection with a base station over a relay; transmitting, to the base station, a radio resource control message based, at least partially, on the request; receiving, from the base station, a message including, at least, a temporary identifier for the at least one user equipment; and transmitting at least the temporary identifier to the at least one user equipment.

In accordance with one aspect, an apparatus comprising: at least one processor; and at least one non-transitory memory including computer program code; the at least one memory and the computer program code configured to, with the at least one processor, cause the apparatus at least to: receive, from a relay user equipment, a radio resource control message; determine that at least one user equipment is requesting to establish a radio resource control connection over a relay based, at least partially, on the received radio resource control message; and transmit, to the relay user equipment, at least a temporary identifier for the at least one user equipment.

In accordance with one aspect, a method comprising: receiving, from a relay user equipment, a radio resource control message; determining that at least one user equipment is requesting to establish a radio resource control connection over a relay based, at least partially, on the received radio resource control message; and transmitting, to the relay user equipment, at least a temporary identifier for the at least one user equipment.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting exemplary system in which the exemplary embodiments may be practiced;

FIG. 2 is a diagram illustrating features as described herein;

FIG. 3 is a diagram illustrating features as described herein;

FIG. 4 is a diagram illustrating features as described herein;

FIG. 5 is a diagram illustrating features as described herein;

FIG. 6 is a diagram illustrating features as described herein;

FIG. 7 is a diagram illustrating features as described herein;

FIG. 8 is a diagram illustrating features as described herein;

FIG. 9 is a flowchart illustrating steps as described herein; and

FIG. 10 is a flowchart illustrating steps as described herein.

### DETAILED DESCRIPTION OF EMBODIMENTS

The following abbreviations that may be found in the specification and/or the drawing figures are defined as follows:
3GPP third generation partnership project
5G fifth generation
5GC 5G core network
AMF access and mobility management function
C-RNTI cell-radio network temporary identifier
CCCH common control channel
CE control element
CU central unit
DCCH dedicated control channel
DTCH dedicated traffic channel
DU distributed unit
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
gNB (or gNodeB) base station for 5G/NR, i.e., a node providing NR user plane and control plane protocol terminations towards the UE, and connected via the NG interface to the 5GC
I/F interface
IE information element
L1 layer 1
LTE long term evolution
MAC medium access control
MME mobility management entity
NAS non access stratum
ng or NG new generation
ng-eNB or NG-eNB new generation eNB
NR new radio
N/W or NW network
PDCP packet data convergence protocol
PHY physical layer
RA random access
RACH random access channel
RAN radio access network
RAR random access response
RF radio frequency
RLC radio link control
RRC radio resource control
RRH remote radio head
RS reference signal
RU radio unit
Rx receiver
SAE system architecture evolution
SDAP service data adaptation protocol
SGW serving gateway
SL sidelink
SMF session management function
SRB signaling radio bearer
S-TMSI SAE temporary mobile station identifier
Tx transmitter
U2N UE-to-Network
UE user equipment (e.g., a wireless, typically mobile device)
UPF user plane function
URLLC ultra reliable low latency

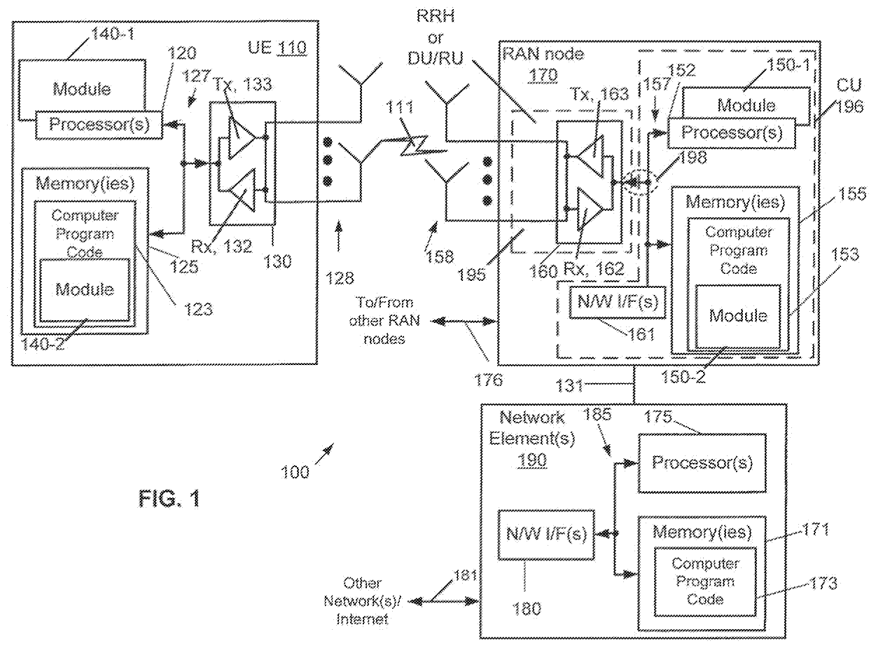

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely exemplary functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Features as described herein generally relate to new radio (NR) sidelink (SL) based UE-to-Network (U2N). Features as described herein may relate to control plane procedures for U2N, including but not limited to radio resource control (RRC) connection management procedures. Features as described herein may relate to the control plane procedure for remote UE to establish/reestablish RRC connection to the gNB, via relay UE, in the context of U2N relay. Features as described herein may relate to initial access of UEs via Layer 2 sidelink relays. In particular, features as described herein may relate to a procedure for the establishment of a connection between a remote UE and a gNB via a relay UE in the context of a U2N (UE-to-Network) relay.

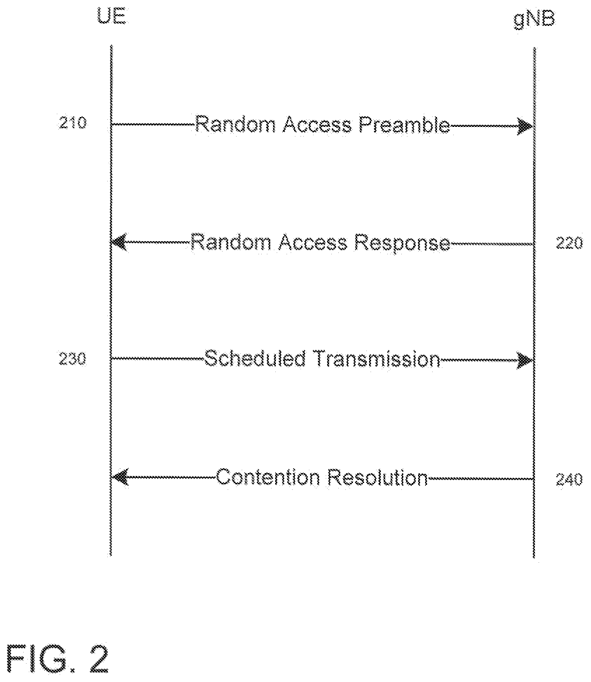

The RRC connection establishment procedure for initial access from a UE in RRC_IDLE state is initiated using 4-step contention based Random Access (RA) procedure. Referring now to FIG. 2, illustrated is an example of a 4-step contention based random access (RA) procedure. At 210, a UE may transmit a random access preamble to a gNB. After receiving a random access preamble, the gNB may transmit a random access response to the UE, at 220. After receiving the random access response, the UE may transmit a scheduled transmission to the gNB, at 230. After receiving the scheduled transmission, the gNB may transmit a message for contention resolution to the UE, at 240.

In the (legacy) initial access procedure for RRC_IDLE state UE to establish an RRC connection, a temporary cell-radio network temporary identifier (C-RNTI) is assigned and indicated in RA response message (i.e. msg2 of RA procedure, e.g. 220 of FIG. 2) from gNB to the UE. The temporary C-RNTI is used to schedule the UL and DL grant of msg3 and msg4 (e.g. 230 and 240 of FIG. 2), in which msg3 and msg4 of RA procedure are RRCSetupRequest and RRCSetup message, respectively, in case of initial access (i.e. UE in RRC_IDLE state). UE-Identity and establishment cause is included in RRCSetupRequest message (i.e. msg3/230) while the SRB1 (Signaling Radio Bearer 1) configuration is included in RRCSetup message (i.e. msg4/240). The UE-Identity in RRCSetupRequest (i.e. msg3/230) is part of NAS UE identity (e.g. SAE temporary mobile station identifier (S-TMSI)) or a random value, which will be used to facilitate the contention resolution of msg4 (e.g. 240). After successful contention resolution in msg4 (e.g. 240), the temporary C-RNTI indicated in msg2 (i.e. RA response, e.g. 220) becomes the C-RNTI of the UE for which the RRC connection is established.

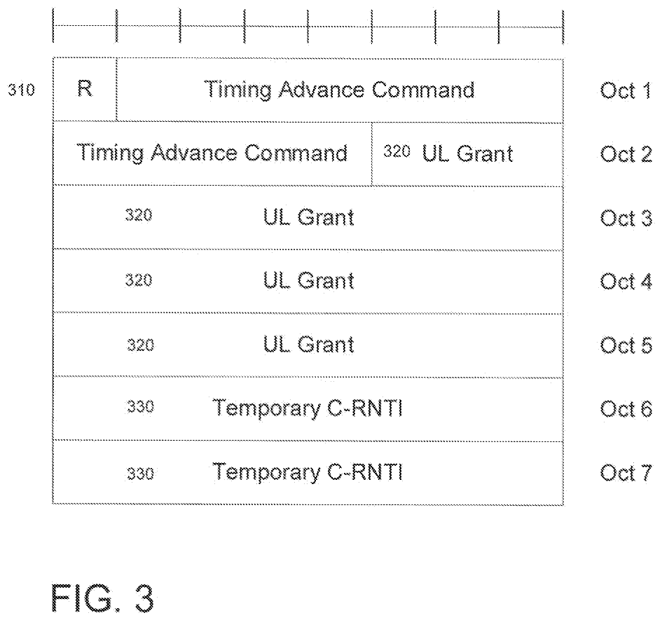

In the (legacy) RRC connection establishment/setup procedure, the C-RNTI is assigned and indicated via RACH procedure, i.e. in msg2/RA response message in the form of a random access response (RAR) medium access control (MAC) control element (CE). Referring now to FIG. 3, illustrated is an example of a RAR MAC CE. It may be noted that, in this example, a temporary C-RNTI 330 may be included in octets 6 and/or 7 of a RAR MAC CE, while an uplink grant 320 may be included in octets 2, 3, 4, and/or 5 (e.g. to enable scheduled transmission 230).

If a UE is in an RRC_INACTIVE state, a similar procedure to that illustrated in FIG. 2 may be applied to transition the UE to RRC_CONNECTED state (i.e. to resume the RRC connection to gNB).

In case of L2 SL relaying/relay path, a remote UE's initial access and RRC connection establishment message exchanges are not performed directly between a remote UE and a gNB, but rather are relayed by a relay UE and/or intermediate relay UEs, in case of multi-hop relay. In other words, there is no direct link between the remote UE and the gNB when performing the initial access and the consequent RRC connection establishment. The messages that are normally exchanged between the two devices are instead relayed by a relay/relays. Thus, a remote UE will not initiate the RA procedure for RRC connection establishment. Without an RA preamble and RA response exchange between remote UE and gNB (e.g. msg1/210 and msg2/220 in FIG. 2), the assignment and indication of temporary C-RNTI (which would become the normal/non-temporary C-RNTI of a remote UE after successful RRC connection establishment) will not be performed for the remote UE. In other words, a remote UE might not receive a random access response comprising a temporary C-RNTI, such as 330 in the example of FIG. 3, due to the relay procedure.

Example embodiments of the present disclosure may enable a gNB to assign a C-RNTI to a remote UE that is using a relay to communicate with the network. Example embodiments of the present disclosure may define which messages/mechanisms a gNB may use to indicate a C-RNTI to a remote UE, without the presence of a random access procedure for the remote UE.

In the present disclosure, the term “remote UE” may be used to refer to a UE that communicates with the network via a relay UE rather than directly. In the present disclosure, the term “relay UE” may be used to refer to a UE that performs relay between one or more remote UE(s) and a network.

In an example embodiment, a remote UE (in a relaying environment) may indicate it's RRC connection establishment/resumption request to a gNB via a relay UE, and the gNB, once it has received the indication from the relay, may assign a C-RNTI to the UE and provide it, in a DL RRC signaling message (e.g. RRCSetup/RRCResume message).

Example embodiments of the present disclosure may relate to the state in which a relay UE is in at the time of the remote UE's request, and the manner therefore, that the signaling can be performed.

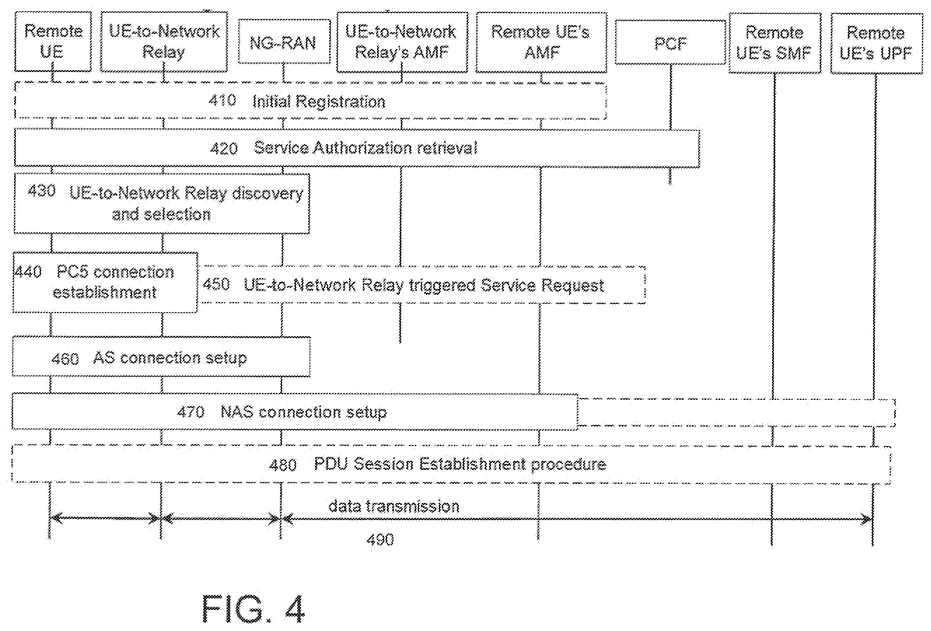

Referring now to FIG. 4, illustrated is an example of the indirect connection establishment procedure of the L2 relay solution for remote UE via UE-to-NW relay UE. At 410, initial registration may, optionally, be performed by Remote UE and UE-to-Network Relay UE independently to remote UE's AMF and UE-to-Network Relay UE's AMF, respectively. At 420, service authorization retrieval may occur at Remote UE and UE-to-Network Relay UE independently from PCF via remote UE's AMF and UE-to-Network Relay UE's AMF, respectively. At 430, UE-to-Network relay discovery and selection may occur between Remote UE and UE-to-Network Relay UE, and, optionally, with the assistance from NG-RAN. At 440, PC5 connection establishment may occur between Remote UE and UE-to-Network Relay UE. At 450, UE-to-Network relay triggered service request may, optionally, occur between UE-to-Network Relay UE and UE-to-Network Relay UE's AMF.

At 460, AS connection setup, the RRC connection establishment of remote UE may be performed. In this step, remote UE may send AS messages to the NG-RAN via the UE-to-NW Relay UE, for example to establish an AS Connection with the same NG-RAN serving the Relay UE. Example embodiments of the present disclosure may relate to RAN level signaling procedures for remote UE's RRC connection establishment in L2 relay.

At 470, NAS connection setup may occur between Remote UE and remote UE's AMF via UE-to-Network Relay UE, NG-RAN, UE-to-Network Relay UE's AMF. Optionally, Remote UE's SMF and/or Remote UE's UPF may also be involved. At 480, PDU session establishment procedure may, optionally, occur between Remote UE, Remote UE's AMF, Remote UE's SMF, and/or Remote UE's UPF via UE-to-NW Relay UE. At 490, data transmission may occur between Remote UE and UE-to-Network Relay UE, between UE-to-Network Relay UE and NG-RAN, and/or between NG-RAN and Remote UE's UPF.

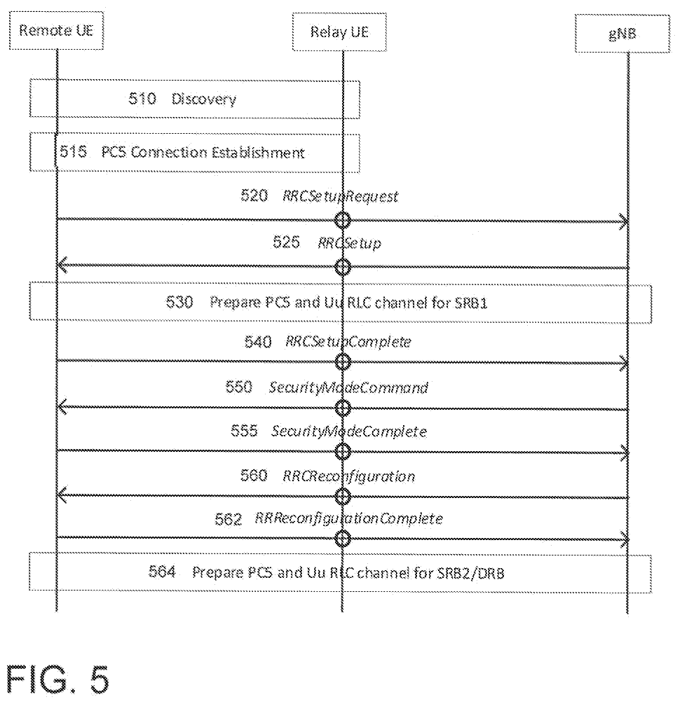

Referring now to FIG. 5, illustrated is an example of L2 UE-to-NW relay connection establishment procedure. At 510, discovery may occur between a remote UE and a relay UE. At 515, PC5 connection establishment may occur between the remote UE and the relay UE.

At 520, the remote UE may transmit a RRCSetup Request via the relay UE to a gNB (e.g. msg3/230 of FIG. 2). At 525, the gNB may transmit an RRCSetup response to the remote UE via the relay UE (e.g. msg4/240 of FIG. 2). The transmission of the RRCSetup Request and RRC Setup may be as follows: the Remote UE may send the first RRC message (i.e., RRCSetupRequest) for its connection establishment with gNB via the Relay UE, using a default L2 configuration on PC5. The gNB may respond with an RRCSetup message to Remote UE. The RRCSetup delivery to the Remote UE may use the default configuration on PC5. If the Relay UE had not started in RRC_CONNECTED, it may need to do its own connection establishment upon reception of a message on the default L2 configuration on PC5.

At 530, PC5 and Uu RLC channel may be prepared for SRB1 between remote UE and relay UE and between relay UE and gNB, respectively. At 540, the remote UE may transmit an RRCSetupComplete message to the gNB via the relay UE. At 550, the gNB may transmit a SecurityModeCommand message to the remote UE via the relay UE. At 555, the remote UE may transmit a SecurityModeComplete message to the gNB via the relay UE. At 560, the gNB may transmit an RRCReconfiguration message to the remote UE via the relay UE. At 562, the remote UE may transmit an RRCReconfigurationComplete message to the gNB via the relay UE. At 564, PC5 and Uu RLC channel may be prepared for SRB2/DRB.

It may be noted that while FIGS. 4 and 5 illustrate only one remote UE and one relay UE, multiple remote UEs and/or multiple relay UEs may be possible in other examples.

Example embodiments of the present disclosure may relate to enabling a gNB to assign and/or indicate a C-RNTI to a remote UE in Sidelink relay during RRC connection establishment/resumption of the remote UE, without involvement of the RA procedure.

In an example embodiment, a relay UE may indicate, either implicitly or explicitly, a remote UE's RRC connection establishment/resumption request to a gNB. In an example embodiment, when the relay UE is in an RRC_CONNECTED state, the remote UE's RRC connection establishment/resumption request may be implicitly indicated by the relay UE. For example, the relay UE may relay the remote UE's RRC signaling message to the gNB via common control channel (CCCH). In an alternative example embodiment, when the relay UE is in an RRC_CONNECTED state, the remote UE's RRC connection establishment/resumption request may be explicitly indicated (e.g. using a new RRC message or message type or a new IE in existing RRC message(s)) by the relay UE. For example, the relay UE may relay the remote UE's RRC signaling message via dedicated control channel (DCCH) or dedicated traffic channel (DTCH) of the relay UE. In an alternative example embodiment, when the relay UE is in an RRC_IDLE or RRC_INACTIVE state, the remote UE's RRC connection establishment/resumption request may be indicated with a new connection establishment/resumption cause or additional UE identity IE. For example, the relay UE may relay the remote UE's RRC connection establishment/resumption request when/while relay UE establishes/resumes its own RRC connection with gNB, in which a new cause or additional UE identity IE may be included.

In an example embodiment, a gNB may be triggered to assign a C-RNTI to a remote UE based on an indication, received from a relay UE, for establishment/resumption of the remote UE's RRC connection, and may indicate the C-RNTI explicitly in the corresponding DL RRC signaling message (e.g. RRCSetup/RRCResume message).

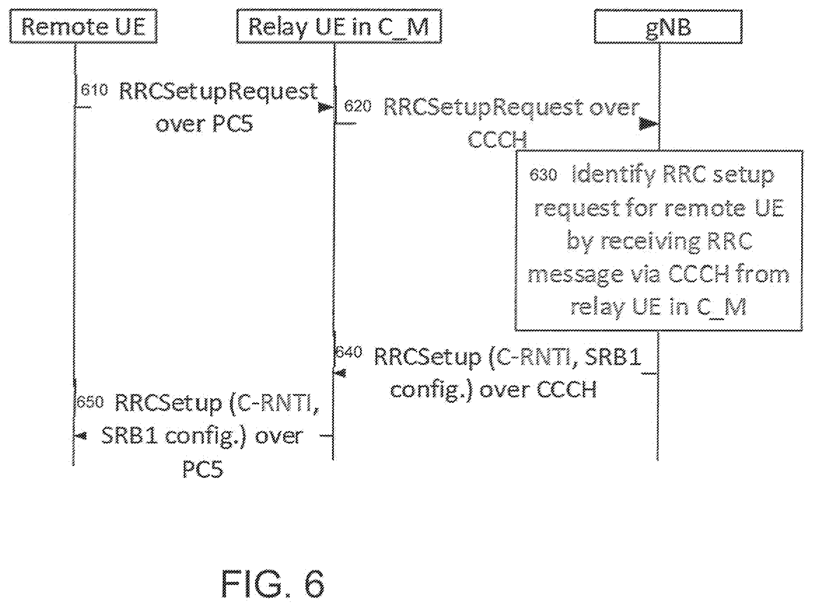

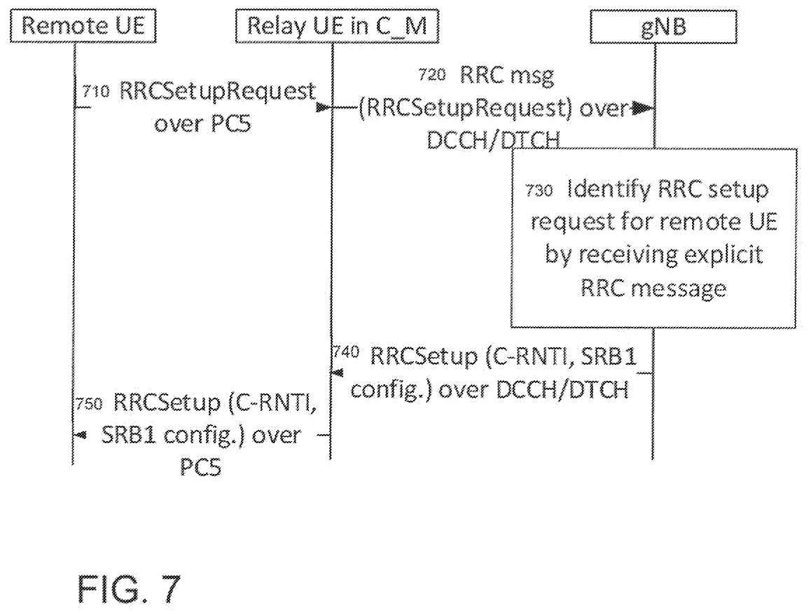

In some examples, a relay UE may be in an RRC_CONNECTED state when a remote UE initiates RRC connection establishment or RRC connection resume from an RRC_IDLE or RRC_INACTIVE state. When the relay UE is in the RRC_CONNECTED state, the remote UE's RRC connection establishment/resume related signaling message(s) may be relayed by the relay UE to a gNB right away using either CCCH or DCCH of the relay UE. Referring now to FIG. 6, illustrated is an example in which a remote UE's RRC connection setup request is transmitted by the relay UE, which is in an RRC_Connected state, to the gNB using CCCH. Referring now to FIG. 7, illustrated is an example in which a remote UE's RRC connection setup request is transmitted by the relay UE, which is in an RRC_Connected state, to the gNB using DCCH/DTCH. It may be noted that while FIGS. 6 and 7 illustrate examples in which the remote UE is in RRC_IDLE state, a similar procedure may be used where the remote UE is in RRC_INACTIVE state; in such cases, a RRCResumeRequest may be transmitted instead of an RRCSetupRequest, and a RRCResume message may be transmitted instead of an RRCSetup message.

In an example embodiment, a RRCSetupRequest message from a remote UE may be transmitted by a relay UE to a gNB via CCCH. In an example embodiment, the gNB, based on receiving the RRC message(s) via CCCH from the relay UE (which may be in RRC_CONNECTED state), may identify/determine that the received RRCSetupRequest message is for the remote UE, instead of the relay UE. Referring now to FIG. 6, at 610, the remote UE may transmit an RRCSetupRequest to the relay UE over PC5 (e.g. msg3/230 of FIG. 2). At 620, the relay UE may relay/transmit the RRCSetupRequest of remote UE over CCCH to the gNB. At 630, the gNB may identify/determine that the RRCSetupRequest is for the remote UE, based on the receiving of the RRC message via CCCH from the relay UE, which is in RRC_CONNECTED state. Based on the determination that the RRCSetupRequest is for/from the remote UE, the gNB may assign a C-RNTI for the remote UE. At 640, the gNB may transmit, over CCCH, an RRCSetup message of remote UE to the relay UE (e.g. msg4/240 of FIG. 2). This message may be intended for the remote UE; it may be intended that the relay UE relay this message to the remote UE. The RRCSetup message may include the assigned C-RNTI and configuration information for SRB1, etc. for the remote UE. At 650, the relay UE may relay/transmit the RRCSetup message to the remote UE over PC5. The RRCSetup message may include configuration information for C-RNTI, SRB1, etc. for the remote UE.

In another example embodiment, a RRCSetupRequest message from a remote UE may be transmitted/relayed, by a relay UE, via DCCH or DTCH of the relay UE. In an example embodiment, the RRCSetupRequest message of the remote UE may need to be explicitly indicated, either using a new RRC signaling message, rather than RRCSetupRequest message, or an explicit indication (e.g. one bit/boolean indication) in the RRCSetupRequest message, so that a gNB, upon receiving the RRCSetupRequest message with the indication or a new RRC signaling message via DCCH/DTCH of the relay UE, may identify/determine that the received message is the RRCSetupRequest message is for the remote UE. For example, the new RRC signaling message of the remote UE may be defined as an RRCSetupRequest or RRCResumeRequest from a remote UE (e.g. RRCSetupRequestRemoteUE or RRCResumeRequestRemoteUE). Such a message may be specific to requesting connection via a relay. Referring now to FIG. 7, at 710, the remote UE may transmit an RRCSetupRequest to the relay UE (which may be in RRC_CONNECTED state) over PC5 (e.g. msg3/230 of FIG. 2). At 720, the relay UE may transmit/relay the RRC message (i.e. RRCSetupRequest to the gNB over DCCH or DTCH. At 730, the gNB may identify/determine that the RRCSetupRequest is for/from the remote UE based on an explicit indication. The explicit indication may be a new RRC signaling message or an explicit indication included in the RRCSetupRequest message. Based on the determination that the RRCSetupRequest is for/from the remote UE, the gNB may assign a C-RNTI for the remote UE. At 740, the gNB may transmit, to the relay UE, an RRCSetup message over DCCH/DTCH (e.g. msg4/240 of FIG. 2). This message may be intended for the remote UE; it may be intended that the relay UE relay this message to the remote UE. The RRC Setup message may include configuration information for the assigned C-RNTI, SRB1, etc. for the remote UE. At 750, the relay UE may relay/transmit the RRCSetup message to the remote UE over PC5. The RRCSetup message may include configuration information for C-RNTI, SRB1, etc. for the remote UE.

In some examples, a relay UE may be in an RRC_IDLE state when a remote UE initiates RRC connection establishment/resume from an RRC_IDLE or RRC_INACTIVE state. When the relay UE is in an RRC_IDLE state, the remote UE's RRC connection establishment request may trigger the relay UE to establish its own RRC connection with a gNB. In an example embodiment, the relay UE may establish its own RRC connection and transition to RRC_CONNECTED state first (i.e. before the remote UE transitions to RRC_CONNECTED state). Then, a RRC connection establishment procedure for the remote UE may proceed according to a procedure illustrated in FIG. 6 or FIG. 7.

In an alternative example embodiment, the relay UE may be triggered to request/transmit/relay the remote UE's RRC connection establishment together with its own RRC connection establishment request. This may occur where the relay UE is in RRC_IDLE/INACTIVE state.

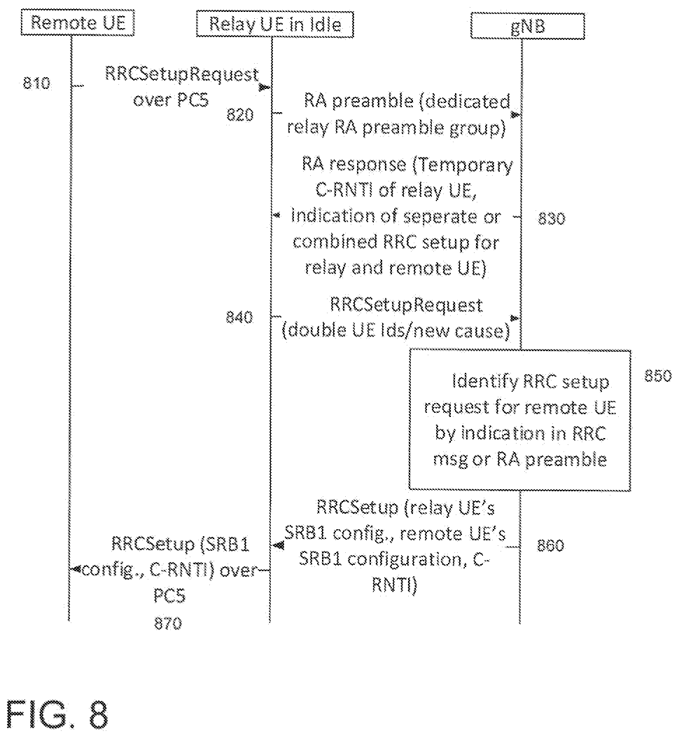

Referring now to FIG. 8, illustrated is an example in which a remote UE initiates an RRC connection establishment procedure when/while a relay UE is in RRC_IDLE state. While not illustrated, a similar procedure may occur when/while the remote UE and/or the relay UE is in RRC_INACTIVE state; in such cases, a RRCResumeRequest may be transmitted instead of an RRCSetupRequest, and a RRCResume message may be transmitted instead of an RRCSetup message. While FIG. 8 illustrates a single remote UE and a single relay UE, multiple remote UEs and/or multiple relay UEs may be involved.

At 820, the remote UE may transmit an RRCSetupRequest over PC5 to the relay UE. At 820, the relay UE, which may be in RRC_IDLE state, may transmit an RA preamble to the gNB (e.g. msg1/210 of FIG. 2). The RA preamble may be a preamble selected from a group of dedicated relay RA preambles. At 830, the gNB may transmit, to the relay UE, an RA response (e.g. msg2/220 of FIG. 2). The RA response may or may not be a MAC RAR CE, a non-limiting example of which is illustrated in FIG. 3. The RA response may include a temporary C-RNTI for the relay UE. The RA response may include an indication for the relay UE to transmit a separate RRC setup message for each of the remote UE and the relay UE or, alternatively, an indication for the relay UE to transmit a combined RRC setup message for the remote UE and the relay UE. At 840, the relay UE may transmit an RRCSetupRequest to the gNB (e.g. msg3/230 of FIG. 2). The RRCSetupRequest may include double UE IDs and/or a new cause. At 850, the gNB may identify the RRC setup request as being a request for/from the remote UE based on an indication in the RRC msg or in the RA preamble. At 860, the gNB may transmit an RRCSetup message to the relay UE (e.g. msg4/240 of FIG. 2). The RCCSetup message may include information intended for the relay UE as well as information intended for the remote UE. The RRCSetup message may include an SRB1 configuration for the relay UE, an SRB1 configuration for the remote UE, and/or a C-RNTI for the remote UE. At 870, the relay UE may transmit/relay all or part of the RRCSetup message to the remote UE over PC5. The RRCSetup message transmitted to the remote UE may include an SRB1 configuration for the remote UE, and/or a C-RNTI for the remote UE.

In an example embodiment, a specific RA preamble group may be configured for the relay UE in RRC_IDLE/INACTIVE state to initiate the RA procedure triggered by remote UE's RRC connection setup request. That is, the relay UE may select one of the (configured) RA preambles from the specific RA preamble group if the relay UE, which is in RRC_IDLE state, is triggered to request RRC connection setup, not for its own control plane (CP) or user plane (UP) traffic, but for relaying remote UE's traffic. In other words, if the relay UE is in an RRC_IDLE/INACTIVE state and receives an RRCSetupRequest/RRCResumeRequest from the remote UE (e.g. msg3/230 of FIG. 2), the relay UE may select an RA preamble (e.g. msg1/210 of FIG. 2) from the configured group of preambles in order to request both its own RRC connection (re)establishment and that of the remote UE. The relay UE may transmit the selected RA preamble to the gNB at 820 of FIG. 8.

In an alternative example embodiment, separate RACH resources may be assigned for the relay UE, which is in an RRC_IDLE/INACTIVE state, to send an RA preamble for requesting both its own RRC connection (re)establishment and that of the remote UE when triggered to request RRC connection (re)establishment for the remote UE (e.g. at 820).

In an example embodiment, when the gNB detects an RA preamble that is from the specific RA preamble group from the relay UE (e.g. at 830), or, alternatively, when the gNB detects a RA preamble transmission from the relay UE via the special RACH resources reserved for relay connection establishment (e.g. at 830), the gNB may know/determine that at least two UEs (i.e. the transmitting relay UE and at least one remote UE) are requesting RRC connection setup. The gNB may determine whether to allow the relay UE to send RRCSetupRequest messages for both UEs, or only the relay UE's request first. In other words, the gNB may determine whether the relay UE may send a combined request for the plural UEs seeking RRC connection, or whether the relay UE may send a request for its own RRC connection first and then a sequential request for RRC connection of the remote UE. In an example embodiment, a reserved bit in a RAR MAC CE (e.g. 310 of FIG. 3) may be used by the gNB to indicate to the relay UE to send a RRCSetupRequest of its own, or both, in msg3 (e.g. 230 in FIG. 2; 830 in FIG. 8).

In an example embodiment, the UL grant of msg3 scheduled by the gNB may be used to indicate to the relay UE to send RRCSetupRequest of its own, or a combined RRCSetupRequest for itself and for the remote UE. That is, the gNB may schedule the corresponding UL grant to/for the relay UE to accommodate only the relay UE's RRCSetupRequest message, or may schedule UL grant for both the relay UE's and the remote UE's messages.

In an example embodiment, upon receiving RAR from the gNB, the relay UE may send RRCSetupRequest message(s) of its own or for both the relay UE and the remote UE(s) based on the indication in R bits or UL grant field of the received RAR MAC CE (e.g. msg2; 840 in FIG. 8). In an example embodiment, RRCSetupRequests from both the relay UE and the remote UE(s) may be indicated via double UE identity IEs in the UL RRC message that relay UE sends to the gNB. For example, the RRC message of the RRCSetupRequest may be extended to include multiple UE identity IEs, each corresponding to the relay UE or a remote UE. For example, more than one remote UE identity IE may be included.

In an example embodiment, a new RRC connection establishment cause may be introduced for the relay UE to request RRC connection establishment for both the relay UE and the remote UE (e.g. msg3; 840 of FIG. 8). This example embodiment may (optionally) be implemented concurrently with the use of specific RA preambles for the relay UE (e.g. at 820 of FIG. 8), and/or the gNB's indication for the relay UE to transmit separate or combined RRC setup messages for the relay UE and remote UE (e.g. at 830 of FIG. 8). That is, the “normal” RA preamble and the RA response may be performed by the relay UE and the gNB, respectively (e.g. at 820, 830 of FIG. 8, while the relay UE may use the new RRC connection establishment cause to indicate to the gNB a request of/for RRC setup for both the relay UE and the remote UE (e.g. at 840 of FIG. 8). In an example embodiment, an additional connection establishment cause may be used to indicate the connection request is for the relay UE and more than one remote UE (e.g. a plurality of remote UEs).

In an example embodiment, when the gNB identifies that the relay UE is requesting the RRC connection setup not only for itself, but also for the remote UE(s) (e.g. at 850 of FIG. 8), the gNB may send combined RRCSetup messages for both the relay UE and the remote UE, in which remote UE's SRB1 configuration as well as C-RNTI are included in addition to relay UE's SRB1 configuration (e.g. at 860 of FIG. 8). In an example embodiment, if multiple remote UE identities are included in the RRCSetupRequest message, or the specific connection establishment cause indicating to setup RRC connections for multiple remote UEs is used, the gNB may decide to accept the request and/or assign SRB1/C-RNTI for a subgroup of the reported remote UEs, e.g. based on NW-implementation. In this case, upon receiving the response from the NW/gNB, the relay UE may forward the configuration to the subgroup of remote UEs while notifying the other remote UEs about the NW's rejection (e.g. at 860 of FIG. 8).

In another example embodiment, if the remote UE is a device requiring URLLC type of services while the NW prefers to serve the remote UE with a direct Uu connection, the gNB may send the RRCSetup message only to the remote UE via the relay UE but reject the request from the relay UE (i.e. the request for relay UE connection). In this case, the relay UE may forward the RRCSetup message to the remote UE and may inform the remote UE to use the configuration contained in the RRCSetup message for setting up a direct Uu connection with the gNB/NW, and for example using the timing advance of the relay UE for direct UL transmission to the gNB. In other words, the gNB may prefer to let the remote UE setup the connection directly to the gNB, not via the relay UE, if the gNB knows that the remote UE is in network coverage. In this case, the gNB may accept the remote UE's connection request, and reject the relay UE's connection request. Accordingly, the relay UE may determine that the gNB prefers to setup connection directly to the remote UE. The relay UE may still need to forward the RRCSetup message to the remote UE, but will not relay the further RRC messages and user plane traffic of the remote UE.

Example embodiments of the present disclosure describe RRC connection establishment when a relay UE and/or a remote UE in RRC_IDLE state attempts transition to RRC_CONNECTED state, but similar example embodiments may be applied for RRC connection resumption, when a relay UE and/or a remote UE in RRC_Inactive state attempts transition to RRC_CONNECTED state. For RRC_INACTIVE state UE, RRCResumeRequest and RRCResume messages may be applied instead of RRCSetupRequest and RRCSetup messages.

In an example embodiment, where the relay UE is in RRC_IDLE state while the remote UE is in RRC_INACTIVE state, the remote UE's RRC connection resumption procedure and the relay UE's RRC connection setup procedure may be combined. In this case, the involved RRC signaling messages may be the mix of relay UE's RRCSetupRequest and remote UE's RRCResumeRequest (e.g. at 820 of FIG. 8), or RRCSetup and RRCResume messages (e.g. at 840 of FIG. 8).

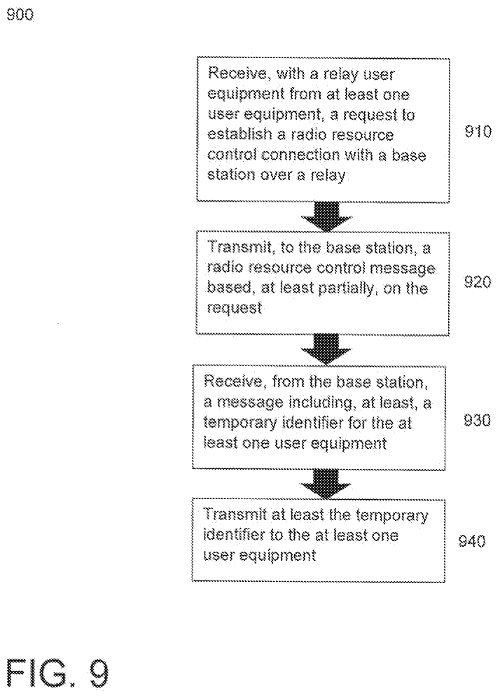

FIG. 9 illustrates the potential steps of an example method 900. The example method 900 may include: receiving, with a relay user equipment from at least one user equipment, a request to establish a radio resource control connection with a base station over a relay, 910; transmitting, to the base station, a radio resource control message based, at least partially, on the request, 920; receiving, from the base station, a message including, at least, a temporary identifier for the at least one user equipment, 930; and transmitting at least the temporary identifier to the at least one user equipment, 940.

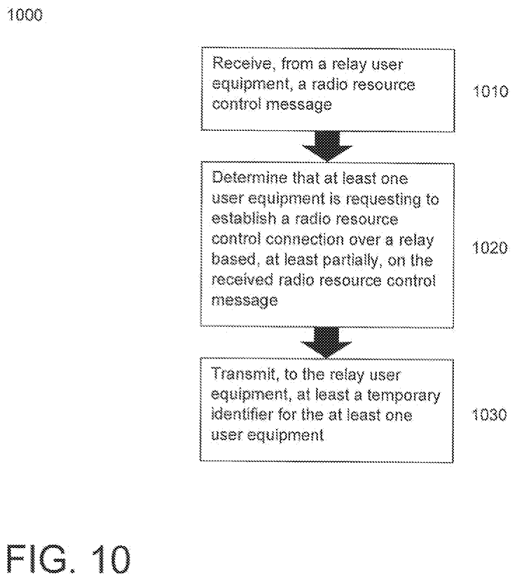

FIG. 10 illustrates the potential steps of an example method 1000. The example method 1000 may include: receiving, from a relay user equipment, a radio resource control message, 1010; determining that at least one user equipment is requesting to establish a radio resource control connection over a relay based, at least partially, on the received radio resource control message, 1020; and transmitting, to the relay user equipment, at least a temporary identifier for the at least one user equipment, 1030.

In accordance with one example embodiment, an apparatus may comprise: at least one processor; and at least one memory including computer program code; the at least one memory and the computer program code configured to, with the at least one processor, cause the apparatus at least to: receive, from at least one user equipment, a request to establish a radio resource control connection with a base station over a relay; transmit, to the base station, a radio resource control message based, at least partially, on the request; receive, from the base station, a message including, at least, a temporary identifier for the at least one user equipment; and transmit at least the temporary identifier to the at least one user equipment.

The radio resource control message may comprise one of: a radio resource control resume request message, or a radio resource control setup request message and wherein the message including, at least, the temporary identifier for the at least one user equipment may comprise one of: a radio resource control resume message, or a radio resource control setup message.

The apparatus may comprise a relay user equipment in a radio resource control connected state, wherein transmitting the radio resource control message may comprise the example apparatus being configured to: transmit the radio resource control message over a dedicated control channel or a dedicated traffic channel, wherein the radio resource control message may comprise one of: a radio resource control connection message specific for requesting to establish the radio resource control connection between the at least one user equipment and the base station over the relay, or a radio resource control connection message comprising an indication configured to request to establish the radio resource control connection between the at least one user equipment and the base station over the relay.

The apparatus may comprise a relay user equipment in a radio resource control connected state, wherein transmitting the radio resource control message may comprise the example apparatus being configured to: transmit the radio resource control message over a common control channel, wherein transmitting the radio resource control message over the common control channel may be configured to indicate that the at least one user equipment is requesting to establish the radio resource control connection with the base station over the relay.

The apparatus may comprise a relay user equipment in one of: a radio resource control inactive state, or a radio resource control idle state.

The example apparatus may be further configured to: transmit, to the base station, a random access preamble, wherein the random access preamble may be at least one of: a random access preamble from a set of random access preambles configured to indicate that the at least one user equipment is requesting to establish a radio resource control connection with the base station over the relay, or transmitted with a random access channel resource configured to indicate that the at least one user equipment is requesting to establish a radio resource control connection with the base station over the relay.

The radio resource control message may comprise one of: an indication of an identifier of the apparatus and an indication of at least one identifier of the at least one user equipment, or a radio resource control connection establishment cause configured to indicate that the at least one user equipment is requesting to establish a radio resource control connection with the base station over the relay.

In accordance with one aspect, an example method may be provided comprising: receiving, with a relay user equipment from at least one user equipment, a request to establish a radio resource control connection with a base station over a relay; transmitting, to the base station, a radio resource control message based, at least partially, on the request; receiving, from the base station, a message including, at least, a temporary identifier for the at least one user equipment; and transmitting at least the temporary identifier to the at least one user equipment.

The radio resource control message may comprise one of: a radio resource control resume request message, or a radio resource control setup request message and wherein the message including, at least, the temporary identifier for the at least one user equipment may comprise one of: a radio resource control resume message, or a radio resource control setup message.

The relay user equipment may be in a radio resource control connected state, wherein the transmitting of the radio resource control message may comprise: transmitting the radio resource control message over a dedicated control channel or a dedicated traffic channel, wherein the radio resource control message comprises one of: a radio resource control connection message specific for requesting to establish the radio resource control connection between the at least one user equipment and the base station over the relay, or a radio resource control connection message comprising an indication configured to request to establish the radio resource control connection between the at least one user equipment and the base station over the relay.

The relay user equipment may be in a radio resource control connected state, wherein the transmitting of the radio resource control message may comprise: transmitting the radio resource control message over a common control channel, wherein the transmitting of the radio resource control message over the common control channel may be configured to indicate that the at least one user equipment is requesting to establish the radio resource control connection with the base station over the relay.

The relay user equipment may be in one of: a radio resource control inactive state, or a radio resource control idle state.

The example method may further comprise: transmitting, to the base station, a random access preamble, wherein the random access preamble may be at least one of: a random access preamble from a set of random access preambles configured to indicate that the at least one user equipment is requesting to establish a radio resource control connection with the base station over the relay, or transmitted with a random access channel resource configured to indicate that the at least one user equipment is requesting to establish a radio resource control connection with the base station over the relay.

The radio resource control message may comprise one of: an indication of an identifier of the relay user equipment and an indication of at least one identifier of the at least one user equipment, or a radio resource control connection establishment clause configured to indicate that the at least one user equipment is requesting to establish a radio resource control connection with the base station over the relay.

In accordance with one example embodiment, an apparatus may comprise: circuitry configured to perform: receive, from at least one user equipment, a request to establish a radio resource control connection with a base station over a relay; transmit, to the base station, a radio resource control message based, at least partially, on the request; receive, from the base station, a message including, at least, a temporary identifier for the at least one user equipment; and transmit at least the temporary identifier to the at least one user equipment.

In accordance with one example embodiment, an apparatus may comprise: processing circuitry; memory circuitry including computer program code, the memory circuitry and the computer program code configured to, with the processing circuitry, enable the apparatus to: receive, from at least one user equipment, a request to establish a radio resource control connection with a base station over a relay; transmit, to the base station, a radio resource control message based, at least partially, on the request; receive, from the base station, a message including, at least, a temporary identifier for the at least one user equipment; and transmit at least the temporary identifier to the at least one user equipment.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for performing: receiving, with a relay user equipment from at least one user equipment, a request to establish a radio resource control connection with a base station over a relay; transmitting, to the base station, a radio resource control message based, at least partially, on the request; receiving, from the base station, a message including, at least, a temporary identifier for the at least one user equipment; and transmitting at least the temporary identifier to the at least one user equipment.

In accordance with one example embodiment, a non-transitory computer-readable medium comprising program instructions stored thereon which, when executed with at least one processor, cause the at least one processor to: receive, from at least one user equipment, a request to establish a radio resource control connection with a base station over a relay; transmit, to the base station, a radio resource control message based, at least partially, on the request; receive, from the base station, a message including, at least, a temporary identifier for the at least one user equipment; and transmit at least the temporary identifier to the at least one user equipment.

In accordance with another example embodiment, a non-transitory program storage device readable by a machine may be provided, tangibly embodying a program of instructions executable by the machine for performing operations, the operations comprising: receive, from at least one user equipment, a request to establish a radio resource control connection with a base station over a relay; transmit, to the base station, a radio resource control message based, at least partially, on the request; receive, from the base station, a message including, at least, a temporary identifier for the at least one user equipment; and transmit at least the temporary identifier to the at least one user equipment.

In accordance with one example embodiment, an apparatus may comprise: at least one processor; and at least one memory including computer program code; the at least one memory and the computer program code configured to, with the at least one processor, cause the apparatus at least to: receive, from a relay user equipment, a radio resource control message; determine that at least one user equipment is requesting to establish a radio resource control connection over a relay based, at least partially, on the received radio resource control message; and transmit, to the relay user equipment, at least a temporary identifier for the at least one user equipment.

The relay user equipment may comprise a relay user equipment in a radio resource control connected state, wherein the radio resource control message may be received over a dedicated control channel or a dedicated traffic channel, wherein the radio resource control message may comprise one of: a radio resource control connection message specific for requesting to establish the radio resource control connection over the relay, or a radio resource control connection message comprising an indication configured to request to establish the radio resource control connection over the relay.

The radio resource control message is received over a common control channel, wherein determining that the at least one user equipment is requesting to establish the radio resource control connection over the relay may be based, at least partially, on receiving the radio resource control message over the common control channel.

The example apparatus may be further configured to: receive a random access preamble from the relay user equipment, wherein the received random access preamble may be at least one of: a random access preamble from a set of random access preambles configured to indicate that the at least one user equipment is requesting to establish the radio resource control connection over the relay, or received with a random access channel resource configured to indicate that the at least one user equipment is requesting to establish the radio resource control connection over the relay, wherein determining that the at least one user equipment is requesting to establish the radio resource control connection over the relay may be further based on the received random access preamble or the random access channel resource from where the random access preamble is received.

The example apparatus may be further configured to: determine whether to allow the relay user equipment to transmit the radio resource control message based, at least partially, on the received random access resource; and indicate, to the relay user equipment, to transmit the radio resource control message, wherein indicating to transmit the radio resource control message may comprise use of: a reserved bit of a random access response medium access control control element, or an uplink grant of the random access response medium access control control element.

In accordance with one aspect, an example method may be provided comprising: receiving, from a relay user equipment, a radio resource control message; determining that at least one user equipment is requesting to establish a radio resource control connection over a relay based, at least partially, on the received radio resource control message; and transmitting, to the relay user equipment, at least a temporary identifier for the at least one user equipment.

The relay user equipment may comprise a relay user equipment in a radio resource control connected state, wherein the radio resource control message may be received over a dedicated control channel or a dedicated traffic channel, wherein the radio resource control message may comprise one of: a radio resource control connection message specific for requesting to establish the radio resource control connection over the relay, or a radio resource control connection message comprising an indication configured to request to establish the radio resource control connection over the relay.

The radio resource control message is received over a common control channel, wherein determining that the at least one user equipment is requesting to establish the radio resource control connection over the relay may be based, at least partially, on receiving the radio resource control message over the common control channel.

The example method may further comprise: receiving a random access preamble from the relay user equipment, wherein the received random access preamble may be at least one of: a random access preamble from a set of random access preambles configured to indicate that the at least one user equipment is requesting to establish the radio resource control connection over the relay, or received with a random access channel resource configured to indicate that the at least one user equipment is requesting to establish the radio resource control connection over the relay, wherein determining that the at least one user equipment is requesting to establish the radio resource control connection over the relay may be further based on the received random access preamble.

The example method may further comprise: determining whether to allow the relay user equipment to transmit the radio resource control message based, at least partially, on the received random access resource; and indicating, to the relay user equipment, to transmit the radio resource control message, wherein indicating to transmit the radio resource control message may comprise use of: a reserved bit of a random access response medium access control control element, or an uplink grant of the random access response medium access control control element.

In accordance with one example embodiment, an apparatus may comprise: circuitry configured to perform: receive, from a relay user equipment, a radio resource control message; determine that at least one user equipment is requesting to establish a radio resource control connection over a relay based, at least partially, on the received radio resource control message; and transmit, to the relay user equipment, at least a temporary identifier for the at least one user equipment.

In accordance with one example embodiment, an apparatus may comprise: processing circuitry; memory circuitry including computer program code, the memory circuitry and the computer program code configured to, with the processing circuitry, enable the apparatus to: receive, from a relay user equipment, a radio resource control message; determine that at least one user equipment is requesting to establish a radio resource control connection over a relay based, at least partially, on the received radio resource control message; and transmit, to the relay user equipment, at least a temporary identifier for the at least one user equipment.

In accordance with one example embodiment, an apparatus may comprise means for performing: receiving, from a relay user equipment, a radio resource control message; determining that at least one user equipment is requesting to establish a radio resource control connection over a relay based, at least partially, on the received radio resource control message; and transmitting, to the relay user equipment, at least a temporary identifier for the at least one user equipment.

In accordance with one example embodiment, a non-transitory computer-readable medium comprising program instructions stored thereon which, when executed with at least one processor, cause the at least one processor to: receive, from a relay user equipment, a radio resource control message; determine that at least one user equipment is requesting to establish a radio resource control connection over a relay based, at least partially, on the received radio resource control message; and transmit, to the relay user equipment, at least a temporary identifier for the at least one user equipment.

In accordance with another example embodiment, a non-transitory program storage device readable by a machine may be provided, tangibly embodying a program of instructions executable by the machine for performing operations, the operations comprising: receive, from a relay user equipment, a radio resource control message; determine that at least one user equipment is requesting to establish a radio resource control connection over a relay based, at least partially, on the received radio resource control message; and transmit, to the relay user equipment, at least a temporary identifier for the at least one user equipment.

In accordance with one example embodiment, an apparatus may comprise: at least one processor; and at least one memory including computer program code; the at least one memory and the computer program code configured to, with the at least one processor, cause the apparatus at least to: transmit, to at least one relay user equipment, a request to establish a radio resource control connection with a base station; and receive, from at least one of the at least one relay equipment, an temporary identifier, wherein the temporary identify is received in a message based, at least partially, on a message from the base station.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

21-36. (canceled)

37. An apparatus comprising:
at least one processor; and
at least one non-transitory memory including computer program code;
the at least one memory and the computer program code configured to, with the at least one processor, cause the apparatus at least to:
receive, from at least one user equipment, a request to establish a radio resource control connection with a base station over a relay;
transmit, to the base station, a radio resource control message based, at least partially, on the request, wherein the radio resource control message comprises a radio resource control setup request message;
receive, from the base station, a message including, at least, a temporary identifier for the at least one user equipment, wherein the message comprises a radio resource control setup message; and
transmit at least the temporary identifier to the at least one user equipment.

38. The apparatus of claim 37,
wherein the apparatus comprises a relay user equipment in a radio resource control connected state,
wherein transmitting the radio resource control message comprises the at least one memory and the computer program code are configured to, with the at least one processor, cause the apparatus at least to:
transmit the radio resource control message over a dedicated control channel or a dedicated traffic channel, wherein the radio resource control message comprises one of:
a radio resource control connection message specific for requesting to establish the radio resource control connection between the at least one user equipment and the base station over the relay, or
a radio resource control connection message comprising an indication configured to request to establish the radio resource control connection between the at least one user equipment and the base station over the relay.

39. The apparatus of claim 37, wherein the apparatus comprises a relay user equipment in one of:
a radio resource control inactive state, or
a radio resource control idle state.

40. The apparatus of claim 39, wherein the at least one memory and the computer program code are further configured to, with the at least one processor, cause the apparatus at least to:
transmit, to the base station, a random access preamble, wherein the random access preamble is at least one of:
a random access preamble from a set of random access preambles configured to indicate that the at least one user equipment is requesting to establish a radio resource control connection with the base station over the relay, or
transmitted with a random access channel resource configured to indicate that the at least one user equipment is requesting to establish a radio resource control connection with the base station over the relay.

41. The apparatus of claim 40, wherein the radio resource control message comprises one of:
an indication of an identifier of the apparatus and an indication of at least one identifier of the at least one user equipment, or
a radio resource control connection establishment cause configured to indicate that the at least one user equipment is requesting to establish a radio resource control connection with the base station over the relay.

42. A method comprising:
receiving, with a relay user equipment from at least one user equipment, a request to establish a radio resource control connection with a base station over a relay;
transmitting, to the base station, a radio resource control message based, at least partially, on the request, wherein the radio resource control message comprises a radio resource control setup request message;
receiving, from the base station, a message including, at least, a temporary identifier for the at least one user equipment, wherein the message comprises a radio resource control setup message; and
transmitting at least the temporary identifier to the at least one user equipment.

43. The method of claim 42, wherein the relay user equipment is in a radio resource control connected state, wherein the transmitting of the radio resource control message comprises:
transmitting the radio resource control message over a dedicated control channel or a dedicated traffic channel, wherein the radio resource control message comprises one of:
a radio resource control connection message specific for requesting to establish the radio resource control connection between the at least one user equipment and the base station over the relay, or
a radio resource control connection message comprising an indication configured to request to establish the radio resource control connection between the at least one user equipment and the base station over the relay.

44. The method of claim 42, wherein the relay user equipment is in one of:
a radio resource control inactive state, or
a radio resource control idle state.

45. The method of claim 42, further comprising:
transmitting, to the base station, a random access preamble, wherein the random access preamble is at least one of:
a random access preamble from a set of random access preambles configured to indicate that the at least one user equipment is requesting to establish a radio resource control connection with the base station over the relay, or
transmitted with a random access channel resource configured to indicate that the at least one user equipment is requesting to establish a radio resource control connection with the base station over the relay.

46. The method of claim 42, wherein the radio resource control message comprises one of:
an indication of an identifier of the relay user equipment and an indication of at least one identifier of the at least one user equipment, or
a radio resource control connection establishment cause configured to indicate that the at least one user equipment is requesting to establish a radio resource control connection with the base station over the relay.

47. An apparatus comprising:
at least one processor; and
at least one non-transitory memory including computer program code;
the at least one memory and the computer program code configured to, with the at least one processor, cause the apparatus at least to:
receive, from a relay user equipment, a radio resource control message;
determine that at least one user equipment is requesting to establish a radio resource control connection over a relay based, at least partially, on the received radio resource control message; and
transmit, to the relay user equipment, at least a temporary identifier for the at least one user equipment.

48. The apparatus of claim 47, wherein the relay user equipment comprises a relay user equipment in a radio resource control connected state,
wherein the radio resource control message is received over a dedicated control channel or a dedicated traffic channel, wherein the radio resource control message comprises one of:
a radio resource control connection message specific for requesting to establish the radio resource control connection over the relay, or
a radio resource control connection message comprising an indication configured to request to establish the radio resource control connection over the relay.

49. The apparatus of claim 47, wherein the at least one memory and the computer program code are further configured to, with the at least one processor, cause the apparatus at least to:
receive a random access preamble from the relay user equipment, wherein the received random access preamble is at least one of:
a random access preamble from a set of random access preambles configured to indicate that the at least one user equipment is requesting to establish the radio resource control connection over the relay, or
received with a random access channel resource configured to indicate that the at least one user equipment is requesting to establish the radio resource control connection over the relay,
wherein determining that the at least one user equipment is requesting to establish the radio resource control connection over the relay is further based on the received random access preamble or the random access channel resource from where the random access preamble is received.

50. The apparatus of claim 47, wherein the at least one memory and the computer program code are further configured to, with the at least one processor, cause the apparatus at least to:
determine whether to allow the relay user equipment to transmit the radio resource control message based, at least partially, on the received random access resource; and
indicate, to the relay user equipment, to transmit the radio resource control message, wherein indicating to transmit the radio resource control message comprises use of: a reserved bit of a random access response medium access control control element, or an uplink grant of the random access response medium access control control element.
